(19) United States
(12) Patent Application Publication
(10) Pub. No.: US 2006/0000347 A1
(43) Pub. Date: Jan. 5, 2006

(54) Acoustical device and method

(76) Inventor: Kenneth Alan Preece, Anaheim, CA (US)

Correspondence Address: GRADY K. BERGEN, 3333 LEE PARKWAY, SUITE 600, DALLAS, TX, 75219, US

(21) Appl. No.: 11/142,487

(22) Filed: Jun. 1, 2005

Related U.S. Application Data
(60) Provisional application No. 60/580,496, filed on Jun. 17, 2004.

(51) Int. Cl. G10H 1/46; G10H 3/12

(52) U.S. Cl. 84/741

(57) ABSTRACT

An acoustical device is provided in the form of a stringed musical instrument having a hollow resonant body. A speaker is coupled to the resonant body so that the speaker generally overlays the strings of the musical instrument. A power supply is mounted to the instrument for powering the speaker. A sound processing device is provided for receiving at least one of a first sound signal that is generated from the strings of the musical instrument and a second sound signal. The sound processing device generates an output signal to the speaker from at least one of the first and second sound signals. The sound processor has at least one non-overall-volume sound effect generating function.

This application claims the benefit of U.S. Provisional Patent Application Ser. No. 60/580,496, filed Jun. 17, 2004, and which is herein incorporated by reference in its entirety.

### BACKGROUND

The invention relates generally to speakers and acoustical devices.

### BRIEF DESCRIPTION OF THE DRAWINGS

For a more complete understanding of the present invention, reference is now made to the following descriptions taken in conjunction with the accompanying figures, in which:

FIG. 1 is a schematic of an acoustical device in the form of an acoustic guitar;

FIG. 2 is a top perspective view an acoustical guitar incorporating a speaker assembly and sound processor;

FIG. 3A is a top plan view of a sound processor employed with the guitar of FIG. 2;

FIG. 3B is a side elevational view of the sound processor of FIG. 3a;

FIG. 4 is a top plan view of an acoustical guitar incorporating a speaker and employing a foot-pedal sound processor;

FIG. 5 is a pair of acoustical guitars, each incorporating a speaker, and which are configured for sending sound signals to the speaker of the other.

### DETAILED DESCRIPTION

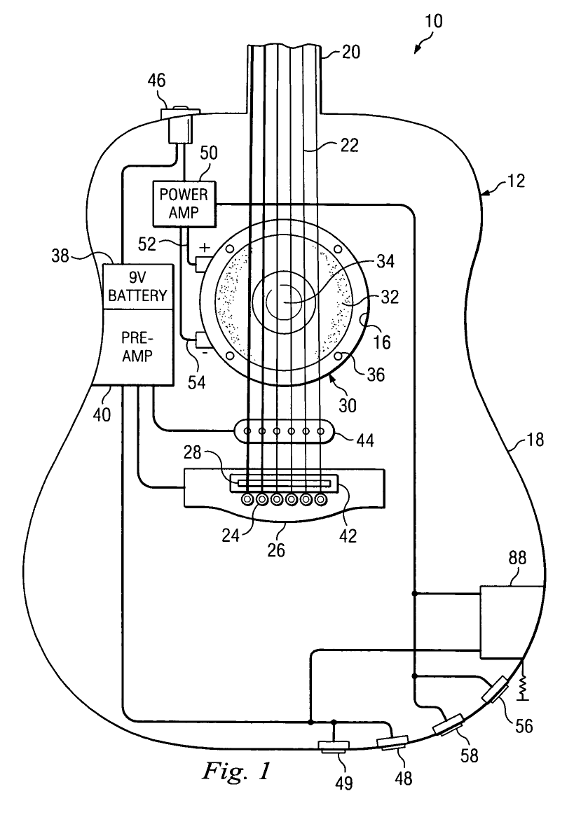

Referring to FIG. 1, an acoustic device 10 of the invention is shown. For purposes of the following description, the acoustic device 10 is shown as a guitar. As will be understood by those skilled in the art, however, the acoustic device 10 may include a variety of other stringed acoustical musical instruments. Non-limiting examples include such acoustical devices as a violin, viola, cello, bass, mandolin, etc.

The guitar or device 10 includes a hollow body portion 12 with a front wall or panel 14 that forms a soundboard having a generally centrally located soundhole or opening 16 formed therein. In the embodiment shown, the soundhole 16 is generally circular in shape. In other embodiments, one or more soundholes may be provided, which may be of a variety of shapes, both circular or non-circular, and may be provided at different positions, centrally and non-centrally located, within the soundboard, such as the S- or f-shaped soundholes commonly employed with violins and the like. The wall 14 is joined by side panels or walls 18 to a rear wall or panel (not shown) to define a hollow interior of the hollow body portion 12.

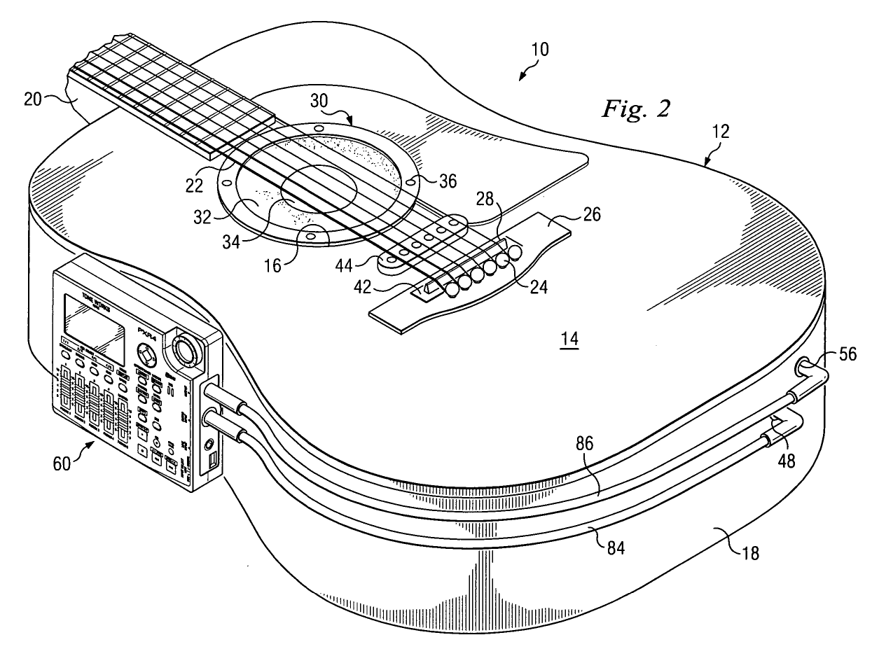

One or more necks 20 extend from the side of the body portion 12. A plurality of strings 22 of the guitar 10 are secured at one end of the neck by means of pegs or other devices (not shown) with the other end of the strings 22 being secured to posts 24 of sound bridge 26 provided on the front panel 14. A saddle 28 may be provided on the bridge 26, with the strings 22 extending and resting against the saddle 28. As shown in FIGS. 1 and 2, the expanse of laterally spaced strings 22 overlays and extends longitudinally across the soundhole 16. In other embodiments, the soundhole or soundholes may be located to the sides of the strings, such as in a violin.

Mounted to the soundboard 14 are one or more speaker assemblies 30. The speaker assembly 30 may be of the type having a diaphragm or cone 32 with a central speaker coil portion 34. As shown in FIG. 1, a single speaker assembly 30 is utilized and faces outwardly and generally overlays and fills the soundhole 16. The diaphragm 32, which may be formed from a polymeric (eg. polypropylene, polystyrene, etc.), fiberglass, Kevlar, graphite paper, metal (eg. aluminum, titanium) or other materials, is positioned so that the speaker coil portion 34 is generally centered directly beneath the lateral expanse of strings 22. The speaker assembly 30 may be secured to the soundboard with woodscrews 36 or other fasteners, which may include mechanical fasteners or glue or adhesive fasteners. Grommets or gaskets, which may be formed from an elastomeric material or resilient damping material, may be interpositioned between the soundboard 14, speaker assembly 30, and/or fasteners 36 for insulating the soundboard 14 from speaker vibrations, which may result in undesirable feedback. An example of a suitable speaker for use in an acoustic guitar includes an approximately four inch aluminum cone speaker. Those rated at 8 ohms with a maximum power handling of 50 watts have been found to be suitable, although other ratings may be used as well.

A self-contained “on-board” power supply 38 is provided with the guitar 10. The power supply 38 may include one or more batteries having a voltage of 1.5 to 9 volts or more. The power supply 38 may be housed within the interior of the body portion 12. In the embodiment shown, a 9 volt battery is used. The guitar or instrument 10 may also be coupled to an external power source, which may be used to power the instrument or to recharge rechargeable batteries, if they are used.

A preamplifier 40 is provided with the device 10. The preamplifier 40 may be that which is typically employed with a conventional electric acoustical guitar having an output jack for connection to an external amplifier. The preamplifier 40 may be powered by power supply 38.

Electrically coupled to the preamplifier 40 may be one or more pickup devices 42, 44. The devices 42, 44 may include magnetic- or piezo-type pickups and may be positioned at different positions under the expanse of strings 22. As shown, the pickup 42, which is a piezo pickup, may be situated between the saddle 28 and sound bridge 26. Alternatively, or in addition, the pickup may be positioned away from the sound bridge, such as the magnetic pickup 44. If more than one pickup is utilized, a selector (not shown) may be provided for selecting the desired pickups.

The preamplifier 40 provides an output to one or more output jacks or sockets, such as the output jacks 48, 49. The output jacks 48, 49 may be conventional ¼ inch output jack or a jack of conventional design and size. The jacks 48, 49 may include any other connector device for providing an output from the preamplifier 40 to an external device. As shown, the output jacks 48, 49 are provided on the sidewall 18 of the guitar 10, although they may be located at other positions to facilitate connection to an external device.

In the embodiment shown, a power switch 46 is provided that switches power from power supply 38 to an onboard power amplifier 50. The power amplifier 50 is connected to the power supply 38 through the switch 46 and provides power to the speaker assembly 30 by means of positive and negative electrical connections 52, 54, respectively. The amplifier 50 is mounted to the guitar 10 and may be housed within the hollow body 12 out of view.

The amplifier 50 provides a boosted signal to the speaker assembly 30 to provide an amplified sound output from the speaker 30. The output of the amplifier 50 may vary, but a suitable range for the power output is from 0.1 to 3 watts or more, with from 0.5 to 2 watts being typical, and from 0.75 to 1.5 watts being more typical. An example of a suitable power amplifier 50 includes that with the following specifications: 1) a DC power input of from 3 to 15 volts Max at 300 mA; 2) a power output of one watt at 8 ohms max; 3) a frequency response of 20 Hz to 20 kHz; and 4) a voltage gain of 30 dB Max.

Coupled to the amplifier 50 are one or more inputs 56, 58. The inputs 56, 58 may be jacks or sockets that are mounted to the guitar or device 10 so that they are accessible to external devices. This may include mounting them in the sidewall 18 or the front or rear panel of the body portion 12. The input jacks 56, 58 may be conventional ¼ inch jacks, mini jacks or other connector devices. Additionally, either or both of the jacks 56, 58 may also include combination input/output jacks for both receiving and sending signals.

By use of the inputs 56, 58, external signals can be fed to the speaker 30 through power amplifier 46. These may be combined with the sound signal from the strings 22 of the instrument itself, such as from pickups 42, 44, which are routed to the power amplifier 50 and speaker 30.

Referring to FIG. 2, a sound processor 60 is provided with the instrument 10. The sound processor 60 may be externally mounted to the hollow body 12 or other portion of the device 10, such as along the sidewall 18. Alternatively, it may be recessed within or built into the device 10. The processor 60 may be removable and replaceable and be releasably coupled to the device 10 by means of releasable fasteners, such as hook and loop or Velcro® fasteners, brackets or other securing devices.

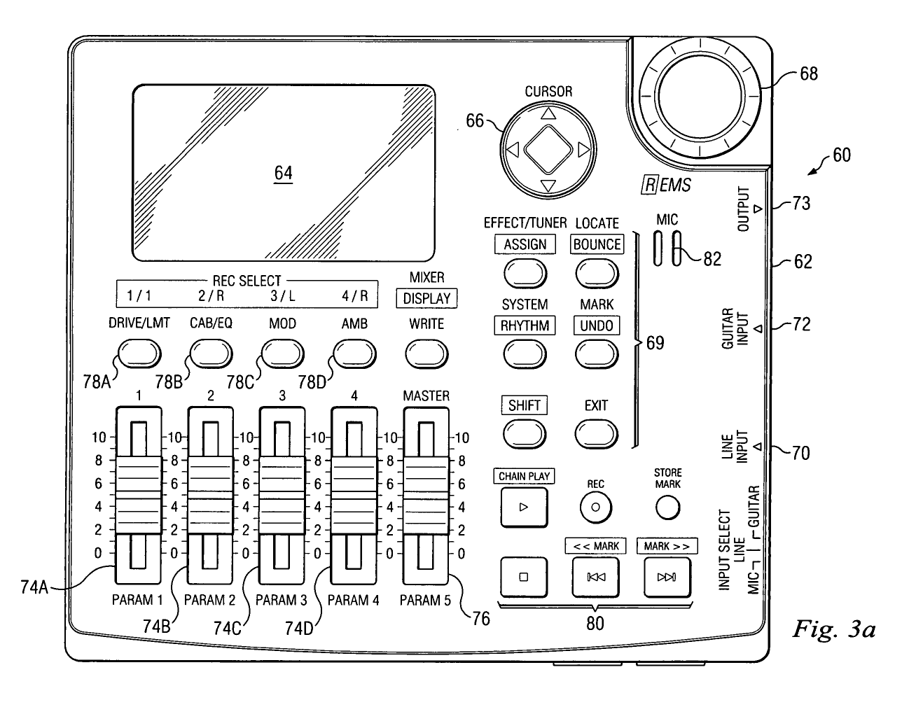

As shown in FIGS. 3A, 3B, the processor 60 is provided with various controls, a display or visual indicators, input and output connections, etc. Although not shown, the processor 60 may also be provided with its own internal power source (such as a battery), memory or electronic data storage area, a data processor, and one or more programs, all contained or housed within a housing 62 of the processor 60. The memory may be a removable type memory, such as a flashcard, etc. As shown, the processor 60 is configured generally as that of a KORG® ToneWorks PXR4 sound processor, available from Korg Inc., Tokyo, Japan. Details of this sound processor may be found in the KORG ToneWorks Pandora PXR4 Owners Manual and the KORG Pandora PXR4 EasyStart guide, which are each hereby incorporated by reference in their entirety. Other sound processors may be employed as well, such as the ZOOM PFX9003 Palmtop Effects Processor, available from Zoom Corporation, Tokyo, Japan.

A display screen 64 may be provided with the processor 60 for displaying level meters for recording and playback, time information, page information for various page displays, processor parameters, and other information. Controls, such as the cursor control 66 and dial control 68, for navigating or moving between page displays and for selecting parameters or adjusting their values may also be provided. Mode controls, such as those indicated at 69, may also be provided on the processor 60.

One or more input jacks, sockets or connectors 70, 72 (FIG. 3B) are provided with the processor 60 for connecting to sound signal input sources. One or more output jacks or connectors 73 may also be provided with the processor.

The processor 60 may include a multiple track recorder and playback for recording and playing multiple tracks. The processor 60 may also allow one or more recorded or provided tracks or a sound input to be combined with others into a single track. Individual volume controls or faders for separate tracks, such as the controls 74A-74D, may be provided for controlling the volume output of each individual track. An overall volume control 76 is also provided with the processor 60 for controlling the overall volume of all tracks. Record select keys 78A-78D may be provided to facilitate recording of individual tracks. Playback controls 80 may also be provided with the processor 60.

The processor 60 may provide other non-overall-volume sound effect generating functions. These may include expansion, equalization, compression, phase shifting, modulation, chorus, delay, reverberation, wah and flanging effects. As used herein, the expression “non-overall-volume sound effect” includes any sound effect that is not merely the adjustment of the overall volume of sound that may be provided as output to the speaker. “Non-overall-volume sound effect” thus may include adjustment of the volume of one or more tracks of a multiple track sound output or the adjustment of certain frequencies or portions of sound output, such as bass and treble sound output. “Non-overall-volume sound effect” may also include the adjustment of the volume of all tracks or portions of the sound output, but where the volume adjustment of such tracks or portions is not uniform with respect to all tracks or all portions of sound output.

The processor 60 may also generate certain sounds, such as drum or percussion-type sounds, rhythm or metronome sound patterns of various types. These may be prerecorded, synthesized or otherwise generated by the processor 60. The tempo of such sound patterns can be continuously varied, such as by use of the dial 68. The processor 60 may provide vocal and non-vocal accompaniment sounds, such as horn or woodwind-type sounds, organ sounds, piano sounds or other keyboard-type sounds, and sounds from numerous stringed instruments, etc. These sounds or a combination thereof may be recorded or stored by the processor 60 or they may be otherwise synthesized or generated by the processor 60. The sounds may constitute sound input to the processor 60, which may then be provided as one or more tracks. Such tracks may, in turn, be modified by the sound processor 60 and recorded as new or different tracks.

A built-in microphone 82 may be provided with the processor 60 for recording vocals or other externally generated sounds that may be picked up by the microphone 82.

Use of the various controls or selectors of the processor 60 may provide a corresponding display on the display 64 indicative of the function or task being performed. Multiple functions may be carried out by using a single key or control or a combination of such keys or controls.

As shown in FIG. 2, the output jack 48 of the guitar 10 is connected to the input jack 72 of the processor 60 by means of cable 84 (egs. 1/4″ shielded cable). Similarly, the output jack 73 of the processor 60 is connected to the input jack 56 of the guitar 10 by means of cable 86 (egs. ⅛″ shielded cable). Other means may also be employed for connecting the inputs and outputs of the processor 60 and guitar 10. For example, the processor 60 may plug directly into connectors provided with the guitar 10 without the use of cables. Furthermore, the processor 60 may be incorporated into or hardwired into the guitar or device 10.

The sound signal output provided from the guitar 10 from strings 22 through output 48 and cable 84 is input into the processor 60 through input connection 72. The received sound signal may be recorded on the device 60 as one or more tracks. One or more sound effects or additional sound tracks may be combined with the recorded guitar input. The sound signal from the guitar strings 22 may also be modified or sound effects applied to the sound signal, such as reverberations, delays, modulations, etc., by the processor 60. The processed sound input may then be stored or recorded in the memory of the processor 60 and/or may be provided as real-time processed or non-processed sound output provided by the processor 60. The stored or recorded sound input may also be used as a single track and combined with other tracks, which may then be stored or recorded as one or more tracks, as well.

The output from the processor 60 may be provided to the speaker 30 from output 73, which may be coupled to the guitar input 56 through cable 86. This input signal is amplified by means of the power amplifier 50 for broadcasting the signal as sound output through speaker 30.

The instrument 10 may also be provided with a wireless device 88 (FIG. 1) that is connected to the speaker 30 through power amplifier 50. The use of Bluetooth™ and other wireless technologies may be used for this purpose. The device 88 may also be coupled to the preamplifier 40 and include a transmitter for transmitting a wireless signal to wireless devices, such as a sound processor or other audio recording or playback devices. Such devices may be mounted on the instrument itself or may be external remote devices. In this way, an electrical signal from the sound processor or other audio device may be transmitted wirelessly for broadcasting sound provided from such devices through the speaker 30. Likewise, sounds produced from the instrument 10 may be transmitted to the wireless sound processor or audio device. This eliminates the need for wiring or cables.

In use, the user of the device 10 may provide prerecorded, synthesized or otherwise generated accompaniment provided from the processor 60. This may be amplified by means of power amplifier 50 and broadcast to the speaker assembly 30 along with sounds from the strings 22 while the instrument is being played. The sound signal from the strings 22, with or without any accompaniment generated from the processor 60, may be looped through the processor 60 and provided as output from the processor 60 to the power amplifier 50 and speaker 30 as processed or unprocessed sound output. Alternatively, the sound signal from the strings 22 may be passed directly from the preamplifier 40 to the power amplifier 50 and speaker 30. In still another mode, the device 10 may be played without amplification of the strings 22, relying instead on the natural resonance of the device 10, but with accompaniment from the processor 60 being broadcast through the speaker 30.

The user may also record the sounds generated from the instrument during a performance using the processor 60. The sound signals generated during the performance may then be processed and stored for play back for future use or accompaniment. Vocals may also be recorded, such as with the microphone 82, and combined with the played instrument sounds onto one or more tracks.

The presence of the speaker 30 within the soundhole 16 does not significantly diminish the sound characteristics of the instrument 10 when it is played without amplification. The speaker assembly 30, however, takes full advantage of the natural sound characteristics of the hollow body 12, providing a full and rich sound that emanates from the instrument. The device 10 is self-contained and portable, allowing the musician complete mobility. The hole-mounted speaker 30 provides amplification for the instrument itself and any played accompaniment. The device 10 does not require any external amplification equipment or an external power source.

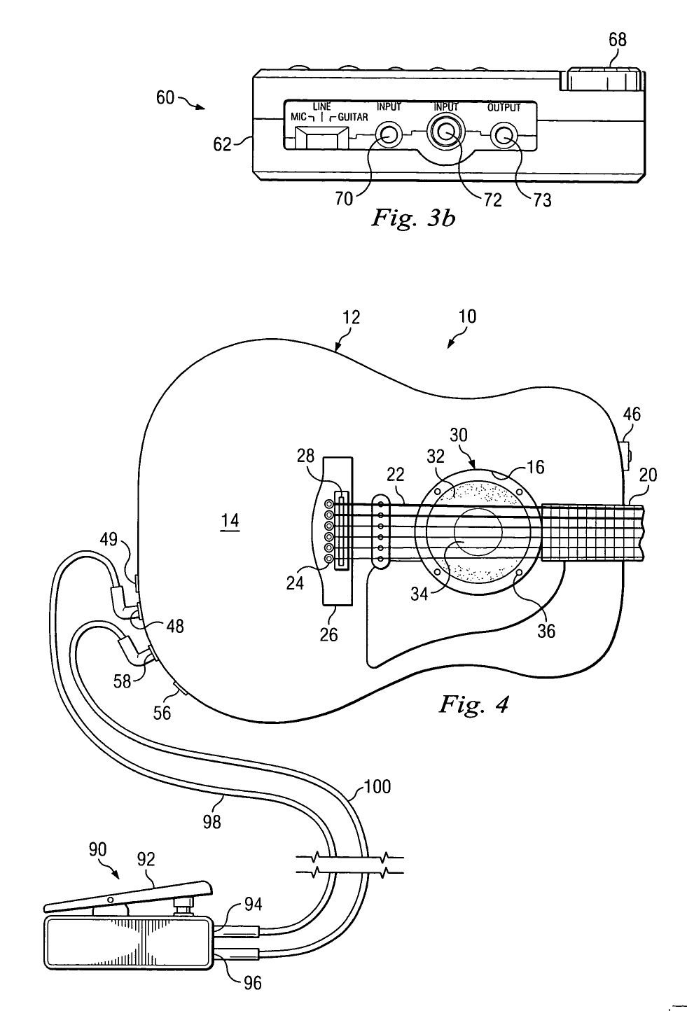

Referring to FIG. 4, in another embodiment the device 10 is shown with a foot-pedal controlled sound processor 90. The various effects applied by the processor 90 may be similar to those provided by the processor 60, discussed previously. The processor 90, however, is controlled, at least in part, by means of one or more pedals 92 that may be operated by the user's foot while playing the device 10. As shown, the processor 90 is provided with input and output jacks 94, 96, respectively. These may be coupled to the output and input jacks of the guitar or device 10 through cables 98, 100. An example of a suitable commercially available foot pedal controlled sound processor is that available as ZOOM GFX-5, available from Zoom Corporation, Tokyo, Japan. Other foot pedal controllers may be suitable as well.

It should be pointed out that digital sound processors have been shown and described for use with the instrument 10. Other playback devices, however, may be used in a similar manner with the device 10, although these may not provide the same sound processing function as the processors described previously. These may include a variety of portable recording and playback digital audio devices, which may record and playback music or sound in a compressed or uncompressed format. Such devices may include minidisc players, DAT players, MP3 players (both disk drive and non-disk drive), PDA's, etc. The devices may relatively small so that they can be externally and releasably mounted to the instrument and so that they may be quickly removed and replaced. The devices may provide both recording and playback functions, including a built-in microphone. The devices allow accompaniment to be provided through the speaker 30 while simultaneously playing the instrument 10. Laptop and desktop computers may also be connected to and used with the instrument 10.

Additionally, the devices may be played without playing of the instrument 10, but with the instrument acting merely as a speaker assembly, taking advantage of the natural resonance and sound characteristics of the hollow body 12 while the connected device is being played.

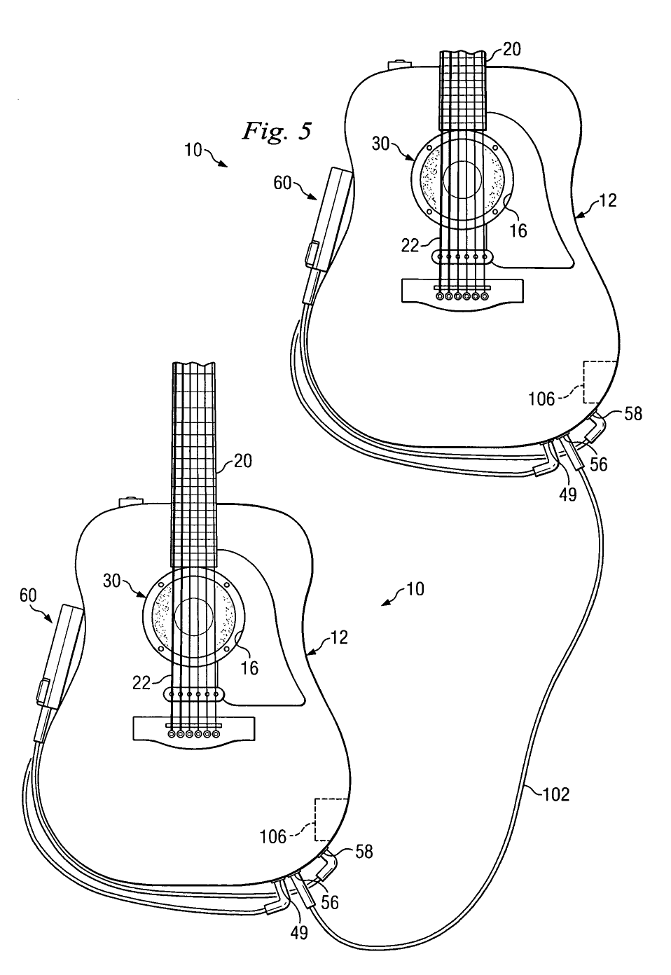

In another mode of operation, two or more of the devices 10, which may be the same or dissimilar, may be coupled together. As shown in FIG. 5, two guitars 10 of similar construction are coupled together for playing in a duet mode so that both instruments may be heard simultaneously through both instrument speakers. In the embodiment shown, the jack 56 of each guitar 10 is a combination input/output jack. The jack, 56 of each of the devices 10 is connected by means of an input/output cable 102 so that the sound signal from either guitar is broadcast through the speaker assembly 30 of the other through the power amplifier 50.

The sound signal produced from each guitar or device 10 may also be fed directly to its associated power amplifier 50 and speaker 30. This may be accomplished by directing the signal from the preamplifier 40 directly to the power amplifier 50. The device 10 may be hardwired in this way, or the output 49 may be coupled to the input 58 by a removable cable or the like. Alternatively, the sound signal produced from each guitar or device may be input into its associated sound processor 60 provided with the device 10 so that processed sound signals from the device 10 may be provided to its associated speaker 30.

Likewise, the output 48 of each of the devices 10 may be provided to the sound processor 60 of the other device 10, such as at inputs 70, 72, so that the sound signal received from the other connected device 10 may be processed and provided as an output to the speaker assembly 30. Accompaniment may also be provided with one or both instruments using the digital processor 60 or other playback device coupled to the instrument. The accompaniment generated from one instrument may be broadcast from the speaker 30 of the other or may be broadcast from the speakers of both instruments.

The instruments 10 may each be provided with a wireless receiver and transmitter 106 for transmitting and receiving sound signals to and from the other, thus eliminating the need for cable 102.

While the invention has been shown in only some of its forms, it should be apparent to those skilled in the art that it is not so limited, but is susceptible to various changes and modifications without departing from the scope of the invention. Accordingly, it is appropriate that the appended claims be construed broadly and in a manner consistent with the scope of the invention.

We claim:

1. An acoustical device comprising:
a stringed musical instrument having a hollow resonant body;
a speaker coupled to the resonant body so that the speaker generally overlays the strings of the musical instrument;
a power supply mounted to the instrument for powering the speaker; and
a sound processing device for receiving at least one of a first sound signal that is generated from the strings of the musical instrument and a second sound signal and generating an output signal to the speaker from at least one of the first and second sound signals, the sound processor having at least one non-overall-volume sound effect generating function.

2. The acoustical device of claim 1, wherein:
the stringed musical instrument includes an electrical pickup for providing the first sound signal to the sound processor.

3. The acoustical device of claim 1, wherein:
the second sound signal is generated from a stored sound source of the sound processing device.

4. The acoustical device of claim 3, wherein:
the stored sound source is provided from an earlier received first sound signal.

5. The acoustical device of claim 1, wherein:
the non-overall-volume sound effect generating function includes at least one of expansion, equalization, compression, phase shifting, modulation, chorus, delay, reverberation, wah and flanging effects.

6. The acoustical device of claim 1, wherein:
the sound processing device includes a foot pedal sound processor.

7. The acoustical device of claim 1, wherein:
the sound processing device is mounted to the musical instrument.

8. The acoustical device of claim 1, wherein:
the resonant body has a soundboard with a soundhole formed therein; and wherein
the speaker is coupled to the soundboard so that the speaker generally overlays the soundhole of the musical instrument.

9. The acoustical device of claims 1, wherein:
the sound processing device receives both the first sound signal and the second sound signal and generates an output signal to the speaker from both the first and second sound signals.

10. The acoustical device of claim 1, wherein:
the second sound signal is provided from a second musical instrument.

11. The acoustical device of claim 1, wherein:
the sound processor is wirelessly coupled to the speaker.

12. An acoustical device comprising:
a stringed musical instrument having a hollow resonant body with a soundboard having a sound hole formed therein;
a speaker coupled to the soundboard so that the speaker generally overlays the soundhole of the musical instrument, the speaker having an amplifier for providing an amplified speaker output;
a pickup for generating an electrical sound signal from the strings of the musical instrument;
a power supply mounted to the instrument for powering at least one of the speaker and pickup; and
a sound processor device for receiving at least one of the electrical sound signal and a second sound signal and generating an output signal to the speaker, the sound processor having at least one non-overall-volume sound effect generating output.

13. The acoustical device of claim 12, wherein:
the second sound signal is from a stored sound source of the sound processing device.

14. The acoustical device of claim 13, wherein:
the stored sound source is provided from an earlier received electrical sound signal.

15. The acoustical device of claim 12, wherein:
the non-overall-volume sound effect generating function includes at least one of expansion, equalization, compression, phase shifting, modulation, chorus, delay, reverberation, wah and flanging effects.

16. The acoustical device of claim 12, wherein:
the sound processing device includes a foot pedal sound effects controller.

17. The acoustical device of claim 12, wherein:
the sound processing device is mounted to the musical instrument.

18. A method of playing musical instruments comprising:
providing first and second musical instruments that generate electrical sound signals while being played, at least one of the musical instruments being an acoustical stringed musical instrument and including:
(a) a hollow resonant body with a soundboard having a sound hole formed therein;
(b) a speaker coupled to the soundboard so that the speaker generally overlays the soundhole of the musical instrument, the speaker having an amplifier for providing an amplified speaker output;
(c) a pickup for generating the electrical sound signal from the strings of the musical instrument; and
(d) a power supply mounted to the instrument for powering at least one of the speaker and pickup; and
transmitting the electrical sound signal generated from the other of the musical instrument to the speaker of the acoustical stringed musical instrument.

19. The method of claim 18, wherein:
each of the first and second instruments is an acoustical stringed musical instrument that includes the elements (a)-(d), and wherein the electrical sound signal generated from at least one of the first and second instruments is transmitted to the speaker of the other of the first and second instruments.

20. The method of claim 18, wherein:
the electrical sound signals are transmitted wirelessly.
